(19) United States
(12) Patent Application Publication
(10) Pub. No.: US 2014/0292467 A1
(43) Pub. Date: Oct. 2, 2014

(54) TRANSFORMER

(71) Applicant: DELTA ELECTRONICS, INC., Kuei San (TW)

(72) Inventor: Chin-Chung Tai, Kuei San (TW)

(73) Assignee: DELTA ELECTRONICS, INC., Kuei San (TW)

(21) Appl. No.: 14/230,386

(22) Filed: Mar. 31, 2014

(30) Foreign Application Priority Data
Apr. 1, 2013 (TW) 102111782
Apr. 1, 2013 (TW) 102111783

(51) Int. Cl. H01F 27/24; H01F 27/29

(52) U.S. Cl. CPC H01F 27/24; H01F 27/29
USPC 336/192; 336/212

(57) ABSTRACT

A transformer includes a first magnetic permeable device, a primary winding wire, a secondary winding wire and a second magnetic permeable device. The primary winding wire and the secondary winding wire are wound on the first magnetic permeable device. The second magnetic permeable device includes a first flange and a second flange. The first flange is disposed at one end of the second magnetic permeable device, and the second flange is disposed at the other end of the second magnetic permeable device. The first flange and the second flange are connected to the first magnetic permeable device. The magnetic permeability of the second magnetic permeable device is larger than that of the first magnetic permeable device.

### CROSS REFERENCE TO RELATED APPLICATIONS

This Non-provisional application claims priority under 35 U.S.C. §119(a) on Patent Application No(s). 102111782 and 102111783 filed in Taiwan, Republic of China on Apr. 1, 2013, the entire contents of which are hereby incorporated by reference.

### BACKGROUND OF THE INVENTION

1. Field of Invention

The present invention relates to a transformer.

2. Related Art

The transformer is an electronic device used for boosting or descending voltage according to the Faraday's Law of induction, and it is mainly applied to increase and decrease the voltage of AC power, to change the impedance or to isolate circuits.

FIG. 1 is a schematic diagram showing a first magnetic permeable device a and a second magnetic permeable device b of a conventional transformer, which are to be wound by winding wires. Referring to FIG. 1, an air gap c is naturally formed in the sintering process due to the structures and shapes of the first magnetic permeable device a and the second magnetic permeable device b. Since the magnetic permeability of air is 1, which is extremely smaller than that of the first magnetic permeable device a, the existing of the air gap 1 leads to a larger resistance for magnetic flow at the junction between the first magnetic permeable device a and the second magnetic permeable device b. This usually decreases the magnetic permeability of the transformer.

Besides, the electronic products are designed with smaller size, and so does the transformer. However, many technical bottlenecks are encountered during the minimization of the transformer. For example, when the size of the transformer is smaller and smaller, the primary and secondary winding wires thereof are too close, so the hi-pot and short circuit therebetween may easily occur as the high voltage is applied. In order to prevent this problem, it is needed to extend the length of the cores for winding the winding wire, which obviously disobeys the goal of minimization.

Therefore, it is an important subject to provide a transformer having a magnetic flux path with high magnetic permeability. Moreover, the withstanding voltage of the transformer can be enhanced without increasing the dimension of the cores, thereby decreasing the risk of hi-pot between the primary and secondary winding wires.

### SUMMARY OF THE INVENTION

In view of the foregoing subject, an objective of the present invention is to provide a transformer having a magnetic flux path with high magnetic permeability. Moreover, the withstanding voltage of the transformer can be enhanced without increasing the dimension of the cores, thereby decreasing the risk of hi-pot between the primary and secondary winding wires.

To achieve the above objective, the present invention discloses a transformer including a first magnetic permeable device, a primary winding wire, a secondary winding wire and a second magnetic permeable device. The primary winding wire and the secondary winding wire are wound on the first magnetic permeable device. The second magnetic permeable device includes a first flange and a second flange. The first flange is disposed at one end of the second magnetic permeable device, and the second flange is disposed at the other end of the second magnetic permeable device. The first flange and the second flange are connected to the first magnetic permeable device. The magnetic permeability of the second magnetic permeable device is larger than that of the first magnetic permeable device.

In one embodiment, the transformer further includes a first electrode, a second electrode, a third electrode, a fourth electrode, a fifth electrode and a sixth electrode. The first magnetic permeable device has three first protrusions and three second protrusions. The first protrusions are separately disposed at one end of the first magnetic permeable device while the second protrusions are separately disposed at the other end of the first magnetic permeable device. The first, second and third electrodes are disposed on the first protrusions, respectively, and the fourth, fifth and sixth electrodes are disposed on the second protrusions, respectively.

In one embodiment, the transformer further includes a first electrode, a second electrode, a third electrode, a fourth electrode, a fifth electrode and a sixth electrode. The first magnetic permeable device has a third flange and a fourth flange. The third flange is disposed at one end of the first magnetic permeable device while the fourth flange is disposed at the other end of the first magnetic permeable device. The first, second and third electrodes are disposed on the third flange, and the fourth, fifth and sixth electrodes are disposed on the fourth flange.

In one embodiment, one end of the secondary winding wire is electrically connected to the fourth electrode, the other end of the secondary winding wire is electrically connected to the fifth electrode, and the secondary winding wire is center tapped to electrically connect to the third electrode.

In one embodiment, the distance between the third electrode and the first electrode and the distance between the third electrode and the second electrode are longer than the distance between the first electrode and the second electrode, and the distance between the sixth electrode and the fourth electrode and the distance between the sixth electrode and the fifth electrode are longer than the distance between the fourth electrode and the fifth electrode.

In one embodiment, the sixth electrode is located at a corner opposite to the third electrode.

To achieve the above objective, the present invention also discloses a transformer including a first magnetic permeable device, a first electrode, a second electrode, a third electrode, a fourth electrode, a fifth electrode, a sixth electrode, a primary winding wire and a secondary winding wire. The first magnetic permeable device includes three first protrusions and three second protrusions. The first protrusions are separately disposed at one end of the first magnetic permeable device while the second protrusions are separately disposed at the other end of the first magnetic permeable device. The first electrode, the second electrode and the third electrode are disposed on the first protrusions, respectively. The fourth electrode, the fifth electrode and the sixth electrode are disposed on the second protrusions, respectively. One end of the primary winding wire is electrically connected to the first electrode, the other end of the primary winding wire is electrically connected to the second electrode, and the primary winding wire is center tapped to electrically connect to the sixth electrode. One end of the secondary winding wire is electrically connected to the fourth electrode, the other end of the secondary winding wire is electrically connected to the fifth electrode, and the secondary winding wire is center tapped to electrically connect to the third electrode.

In one embodiment, the first magnetic permeable device further includes a first flange and a second flange disposed at two ends of the first magnetic permeable device, respectively, and located at planes opposite to the planes where the first protrusions and the second protrusions are located.

In one embodiment, the transformer further includes a second magnetic permeable device connected to the first magnetic permeable device so as to form a magnetic flux path.

In one embodiment, the distance between the third electrode and the first electrode and the distance between the third electrode and the second electrode are longer than the distance between the first electrode and the second electrode.

In one embodiment, the distance between the sixth electrode and the fourth electrode and the distance between the sixth electrode and the fifth electrode are longer than the distance between the fourth electrode and the fifth electrode.

In one embodiment, the sixth electrode is located at a corner opposite to the third electrode.

In one embodiment, the fourth electrode and the fifth electrode are located at a corner opposite to the first electrode and the second electrode.

In one embodiment, the magnetic permeability of the second magnetic permeable device is larger than that of the first magnetic permeable device.

As mentioned above, in the transformer of the invention, two ends of the second magnetic permeable device are configured with a first flange and a second flange, so that the risk of deformations of the first and second magnetic permeable devices during the sintering procedure can be sufficiently decreased. This can prevent the generation of the undesired air gap. In addition, since the proportion of the material with high magnetic permeability in the magnetic flux path increases, the magnetic permeability of the entire transformer can be further increased.

Moreover, there are three first protrusions and three second protrusions separately disposed at two ends of the first magnetic permeable device, and each of the first and second protrusions is configured with a corresponding electrode for electrically connecting to the primary or secondary winding wire. Accordingly, the withstanding voltage of the transformer can be enhanced without increasing the dimension of the first magnetic permeable device, thereby decreasing the risk of hi-pot between the primary and secondary winding wires. This can be achieved by the fact that the creeping withstanding voltage of each electrode is smaller than the withstanding voltage of air. Accordingly, when the creeping distance between the primary and secondary winding wires increases without enlarging the air distance, the withstanding voltage of the entire transformer can be improved as the dimension of the transformer is not increased. In more specific, since the protrusions can increase the creeping distance between the primary and secondary winding wires, the withstanding voltage of the entire transformer can be improved without increasing the dimension of the transformer.

### BRIEF DESCRIPTION OF THE DRAWINGS

The present invention will become more frilly understood from the subsequent detailed description and accompanying drawings, which are given by way of illustration only, and thus are not limitative of the present invention, and wherein:

FIG. 1 is a side view of a conventional transformer;

FIG. 2 is schematic diagram showing a transformer according to an embodiment of the invention;

FIG. 3A is a side view of a first magnetic permeable device and a second magnetic permeable device;

FIG. 3B is a top view of the first magnetic permeable device;

FIG. 4 is a schematic diagram showing another transformer according to the embodiment of the invention;

FIG. 5 is a side view of a first magnetic permeable device and a second magnetic permeable device;

FIG. 6 is a schematic diagram showing another transformer according to the embodiment of the invention; and

FIG. 7 is a side view of a first magnetic permeable device.

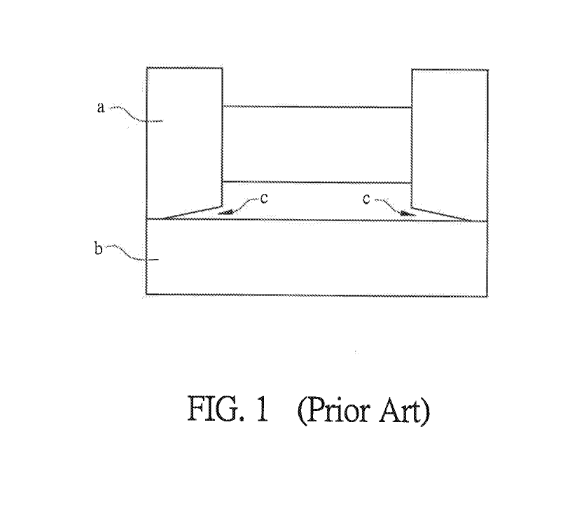

### DETAILED DESCRIPTION OF THE INVENTION

The present invention will be apparent from the following detailed description, which proceeds with reference to the accompanying drawings, wherein the same references relate to the same elements. To be noted, the drawings are for illustrations only and are not to limit the dimensions and scales of the real objects. The real dimensions and scales thereof may have different designs according to the actual requirement.

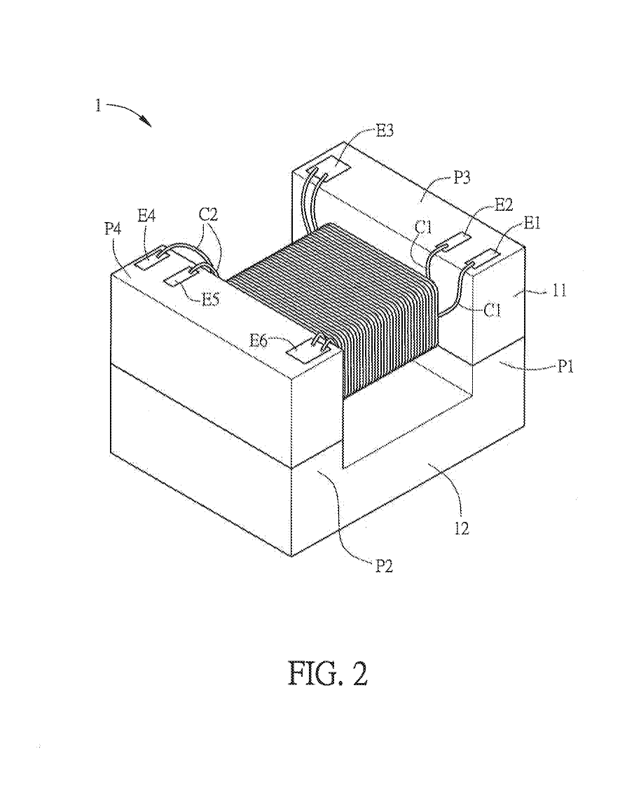

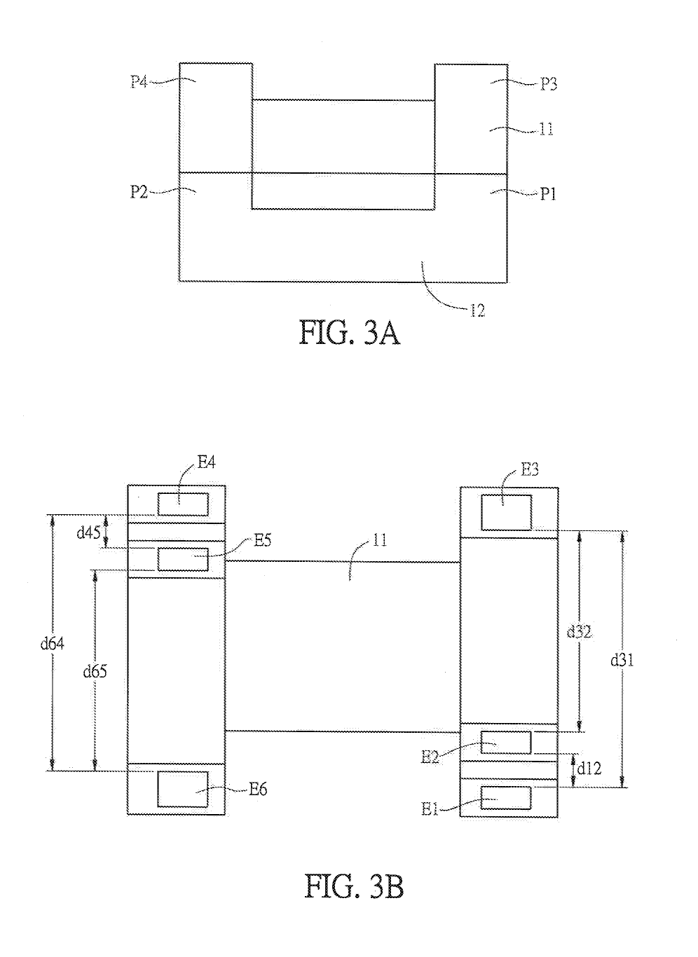

FIG. 2 is schematic diagram showing a transformer 1 according to an embodiment of the invention, FIG. 3A is a side view of a first magnetic permeable device 11 and a second magnetic permeable device 12, and FIG. 3B is a top view of the first magnetic permeable device 11. Referring to FIG. 2 in view of FIGS. 3A and 3B, the transformer 1 includes a first magnetic permeable device 11, a primary winding wire C1, a secondary winding wire C2 and a second magnetic permeable device 12.

The first magnetic permeable device 11 is, for example, silicon steel sheet, iron core, aluminum silicoferrite, nickel steel sheet or any suitable material. The magnetic permeability of the first magnetic permeable device 11 may different depending on various materials, and this invention is not limited.

The primary winding wire C1 is wound on the first magnetic permeable device 11, and the secondary winding wire C2 is also wound on the first magnetic permeable device 11.

The second magnetic permeable device 12 includes a first flange P1 and a second flange P2. The first flange P1 is disposed at one end of the second magnetic permeable device 12, while the second flange P2 is disposed at the other end of the second magnetic permeable device 12. The first flange P1 and the second flange P2 are connected to the first magnetic permeable device 11. The first magnetic permeable device 11 and the second magnetic permeable device 12 are separately manufactured by, for example, sintering, and then connected in the following process. In this embodiment, the magnetic permeability of the second magnetic permeable device 12 is larger than that of the first magnetic permeable device 11.

To be noted, the structure of the above-mentioned second magnetic permeable device 12, which includes the first flange P1 and the second flange P2 at two ends thereof; has a “U” shape, while the structure of the first magnetic permeable device 11 is modified as the side view thereof is changed from an “H” shape to a “U” shape. Accordingly, the deformation of the first magnetic permeable device 11, which may cause the undesired air gap, can be minimized or eliminated during the sintering process of the first magnetic permeable device 11 and the second magnetic permeable device 12. Besides, since the magnetic permeability of the second magnetic permeable device 12 is larger than that of the first magnetic permeable device 11, the proportion of the material with high magnetic permeability in the magnetic flux path increases, thereby further increasing the magnetic permeability of the entire transformer.

In this embodiment, the transformer 1 further includes a first electrode E1, a second electrode E2, a third electrode E3, a fourth electrode E4, a fifth electrode E5 and a sixth electrode E6. In addition, the first magnetic permeable device 11 includes a third flange P3 and a fourth flange P4.

The first electrode E1, the second electrode E2 and the third electrode E3 are disposed on the third flange P3, and the fourth electrode E4, the fifth electrode E5 and the sixth electrode E6 are disposed on the fourth flange P4.

Moreover, one end of the primary winding wire C1 is electrically connected to the first electrode E1, and the other end thereof is electrically connected to the second electrode E2. Besides, the primary winding wire C1 is center tapped to electrically connect to the sixth electrode E6. Alternatively, the primary winding wire C1 may be composed of two individual wires. In this case, the two wires have one end electrically connected to the first electrode E1 and the second electrode E2, respectively, and the other ends of the two wires are both electrically connected to the sixth electrode E6 so as to form the center tap design of the primary winding wire C1.

One end of the secondary winding wire C2 is electrically connected to the fourth electrode E4, and the other end thereof is electrically connected to the fifth electrode E5. Besides, the secondary winding wire C2 is center tapped to electrically connect to the third electrode E3. Alternatively, the secondary winding wire C2 may be composed of two individual wires. In this case, the two wires have one end electrically connected to the fourth electrode E4 and the fifth electrode E5, respectively, and the other ends of the two wires are both electrically connected to the third electrode E3 so as to form the center tap design of the secondary winding wire C2.

As mentioned above, the two ends and the center tapped portion of the primary winding wire C1 are located at two opposite ends of the first magnetic permeable device 11, and the two ends and the center tapped portion of the secondary winding wire C2 are also located at two opposite ends of the first magnetic permeable device 11. This configuration can decrease the risk of hi-pot when applying high voltage to the transformer 1. In other words, the transformer 1 of the present invention can achieve the goal of enhancing the withstanding voltage without increasing the distance between two ends of the first magnetic permeable device 11.

Preferably, in this embodiment, the distance d31 between the third electrode E3 and the first electrode E1 and the distance d32 between the third electrode E3 and the second electrode E2 are longer than the distance d12 between the first electrode E1 and the second electrode E2. According to this design, the risk of hi-pot between two ends of the primary winding wire C1 and the center tap portion of the secondary winding wire C2 can be further reduced, thereby improving the withstanding voltage of the transformer 1.

Similarly, the distance d64 between the sixth electrode E6 and the fourth electrode E4 and the distance d65 between the sixth electrode E6 and the fifth electrode E5 are longer than the distance d45 between the fourth electrode E4 and the fifth electrode E5, thereby increasing the withstanding voltage of the transformer 1.

Moreover, in the transformer 1, the sixth electrode E6 is located at a corner opposite to the third electrode E3, and the fourth electrode E4 and the fifth electrode E5 are located at a corner opposite to the first electrode E1 and the second electrode E2. In practice, this configuration can further increase the distance between the center tap portions of the primary winding wire C1 and the secondary winding wire C2, thereby increasing the withstanding voltage of the transformer 1.

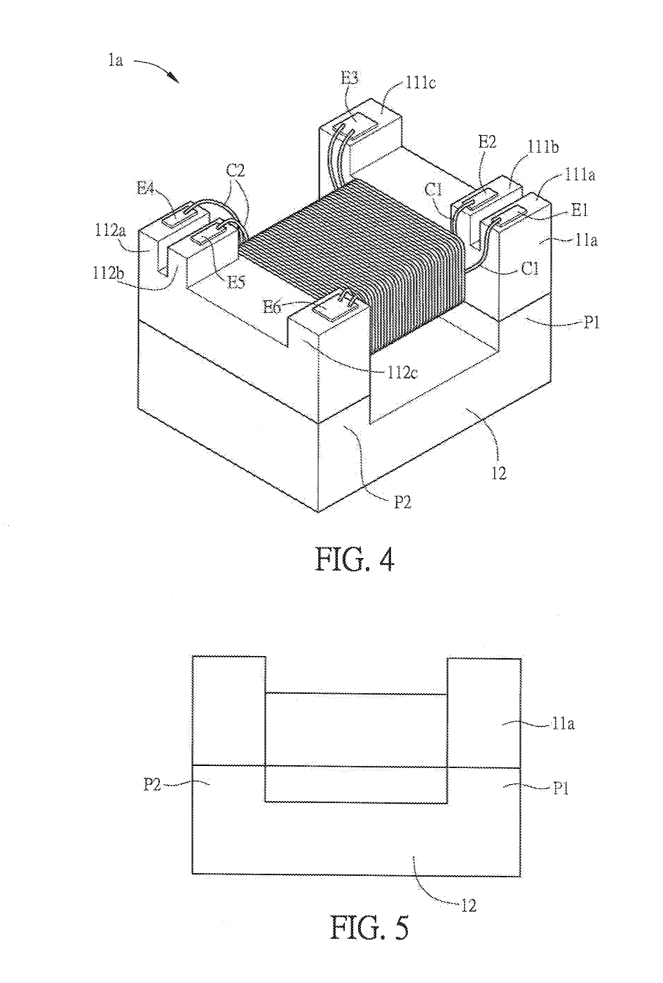

FIG. 4 is a schematic diagram showing another transformer 1a according to the embodiment of the invention, and FIG. 5 is a side view of a first magnetic permeable device 11a and a second magnetic permeable device 12. Referring to FIG. 4 in view of FIG. 5, the transformer 1a is mostly the same as the transformer 1 in structure, and their difference will be described hereinafter while the same parts will be omitted.

Different from the transformer 1, the transformer 1a includes a first magnetic permeable device 11a having a structure different from the first magnetic permeable device 11. The first magnetic permeable device 11a includes three first protrusions 111a-111c and three second protrusions 112a-112c instead of the third flange P3 and the fourth flange P4. The first protrusions 111a-111c are separately disposed at one end of the first magnetic permeable device 11a while the second protrusions 112a-112c are separately disposed at the other end of the first magnetic permeable device 11.a.

Although the structures of the first magnetic permeable devices 11 and 11a are a little different, the operation principle of the transformer 1a is still the same as that of the transformer 1, which can be referred to the above embodiment and will not be repeated. To be noted, the configuration of the first protrusions 111a-111c and the second protrusions 112a-112c can provide a higher isolation effect to the electrodes, thereby increasing the withstanding voltage of the transformer and decreasing the risk of hi-pot.

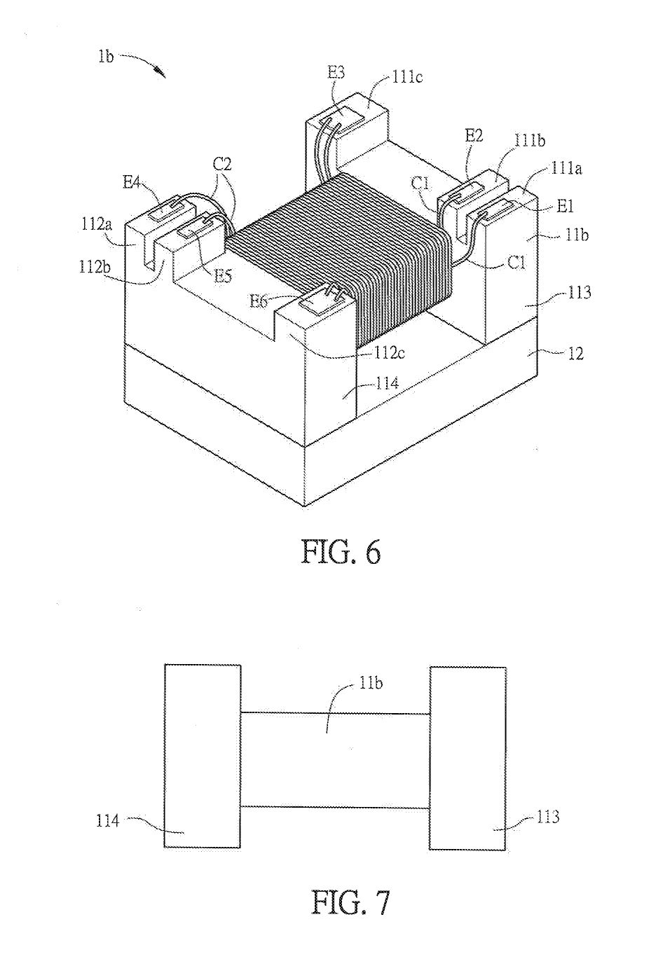

FIG. 6 is a schematic diagram showing another transformer 1b according to the embodiment of the invention, and FIG. 7 is a side view of a first magnetic permeable device 11b. Referring to FIG. 6 in view of FIG. 7, the transformer 1b is mostly the same as the transformer 1a in structure, and their difference will be described hereinafter while the same parts will be omitted.

The first magnetic permeable device 11b of the transformer 1b further includes a first flange 113 and a second flange 114. The first flange 113 is disposed at one end of the first magnetic permeable device 11b, while the second flange 114 is disposed at the other end of the first magnetic permeable device 11b. The first flange 113 and the second flange 114 are located at planes opposite to the planes where the first protrusions 111a-111c and the second protrusions 112a-112c are located. The configuration of the first flange 113 and the second flange 114 can increase the winding number of the primary winding wire C1 and the secondary winding wire C2, thereby enhancing the electromagnetic characteristics of the transformer 1b.

Although the structures of the first magnetic permeable devices 11a and 11b are a little different, the operation principle of the transformer 1b is still the same as that of the transformer 1b, which can be referred to the above embodiment and will not be repeated.

To sum up, in the transformer of the invention, two ends of the second magnetic permeable device are configured with a first flange and a second flange, so that the risk of deformations of the first and second magnetic permeable devices during the sintering procedure can be sufficiently decreased. This can prevent the generation of the undesired air gap. In addition, since the proportion of the material with high magnetic permeability in the magnetic flux path increases, the magnetic permeability of the entire transformer can be further increased.

Moreover, there are three first protrusions and three second protrusions separately disposed at two ends of the first magnetic permeable device, and each of the first and second protrusions is configured with a corresponding electrode for electrically connecting to the primary or secondary winding wire. Accordingly, the withstanding voltage of the transformer can be enhanced without increasing the dimension of the first magnetic permeable device, thereby decreasing the risk of hi-pot between the primary and secondary winding wires. This can be achieved by the fact that the creeping withstanding voltage of each electrode is smaller than the withstanding voltage of air. Accordingly, when the creeping distance between the primary and secondary winding wires increases without enlarging the air distance, the withstanding voltage of the entire transformer can be improved as the dimension of the transformer is not increased. In more specific, since the protrusions can increase the creeping distance between the primary and secondary winding wires, the withstanding voltage of the entire transformer can be improved without increasing the dimension of the transformer.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A transformer, comprising:
a first magnetic permeable device;
a primary winding wire wound on the first magnetic permeable device;
a secondary winding wire wound on the first magnetic permeable device; and
a second magnetic permeable device comprising a first flange and a second flange, wherein the first flange is disposed at one end of the second magnetic permeable device while the second flange is disposed at the other end of the second magnetic permeable device, the first flange and the second flange are connected to the first magnetic permeable device, and the magnetic permeability of the second magnetic permeable device is larger than that of the first magnetic permeable device.

2. The transformer of claim 1, further comprising:
a first electrode, a second electrode, a third electrode, a fourth electrode, a fifth electrode and a sixth electrode;
wherein, the first magnetic permeable device has three first protrusions and three second protrusions, the first protrusions are separately disposed at one end of the first magnetic permeable device while the second protrusions are separately disposed at the other end of the first magnetic permeable device, the first electrode, the second electrode and the third electrode are disposed on the first protrusions, respectively, and the fourth electrode, the fifth electrode and the sixth electrode are disposed on the second protrusions, respectively.

3. The transformer of claim 2, wherein one end of the secondary winding wire is electrically connected to the fourth electrode, the other end of the secondary winding wire is electrically connected to the fifth electrode, and the secondary winding wire is center tapped to electrically connect to the third electrode.

4. The transformer of claim 2, wherein the distance between the third electrode and the first electrode and the distance between the third electrode and the second electrode are longer than the distance between the first electrode and the second electrode, and the distance between the sixth electrode and the fourth electrode and the distance between the sixth electrode and the fifth electrode are longer than the distance between the fourth electrode and the fifth electrode.

5. The transformer of claim 2, wherein the sixth electrode is located at a corner opposite to the third electrode.

6. The transformer of claim 1, further comprising:
a first electrode, a second electrode, a third electrode, a fourth electrode, a fifth electrode and a sixth electrode;
wherein, the first magnetic permeable device has a third flange and a fourth flange, the third flange is disposed at one end of the first magnetic permeable device while the fourth flange is disposed at the other end of the first magnetic permeable device, the first electrode, the second electrode and the third electrode are disposed on the third flange, and the fourth electrode, the fifth electrode and the sixth electrode are disposed on the fourth flange.

7. The transformer of claim 6, wherein one end of the secondary winding wire is electrically connected to the fourth electrode, the other end of the secondary winding wire is electrically connected to the fifth electrode, and the secondary winding wire is center tapped to electrically connect to the third electrode.

8. The transformer of claim 6, wherein the distance between the third electrode and the first electrode and the distance between the third electrode and the second electrode are longer than the distance between the first electrode and the second electrode, and the distance between the sixth electrode and the fourth electrode and the distance between the sixth electrode and the fifth electrode are longer than the distance between the fourth electrode and the fifth electrode.

9. The transformer of claim 6, wherein the sixth electrode is located at a corner opposite to the third electrode.

10. A transformer, comprising:
a first magnetic permeable device comprising three first protrusions and three second protrusions, wherein the first protrusions are separately disposed at one end of the first magnetic permeable device while the second protrusions are separately disposed at the other end of the first magnetic permeable device;
a first electrode, a second electrode and a third electrode disposed on the first protrusions, respectively;
a fourth electrode, a fifth electrode and a sixth electrode disposed on the second protrusions, respectively;
a primary winding wire, wherein one end of the primary winding wire is electrically connected to the first electrode, the other end of the primary winding wire is electrically connected to the second electrode, and the primary winding wire is center tapped to electrically connect to the sixth electrode; and
a secondary winding wire, wherein one end of the secondary winding wire is electrically connected to the fourth electrode, the other end of the secondary winding wire is electrically connected to the fifth electrode, and the secondary winding wire is center tapped to electrically connect to the third electrode.

11. The transformer of claim 10, wherein the first magnetic permeable device further comprises a first flange and a second flange disposed at two ends of the first magnetic permeable device, respectively, and located at planes opposite to the planes where the first protrusions and the second protrusions are located.

12. The transformer of claim 10, further comprising a second magnetic permeable device connected to the first magnetic permeable device so as to form a magnetic flux path.

13. The transformer of claim 10, wherein the distance between the third electrode and the first electrode and the distance between the third electrode and the second electrode are longer than the distance between the first electrode and the second electrode.

14. The transformer of claim 10, wherein the distance between the sixth electrode and the fourth electrode and the distance between the sixth electrode and the fifth electrode are longer than the distance between the fourth electrode and the fifth electrode.
